(19) United States
(12) Patent Application Publication
(10) Pub. No.: US 2016/0214191 A1
(43) Pub. Date: Jul. 28, 2016

(54) SAW SET FOR SAW CHAIN TEETH

(71) Applicant: TOSHIYUKI MIZUKAMI, (US)

(72) Inventor: TOSHIYUKI MIZUKAMI, (US)

(21) Appl. No.: 15/026,086

(22) PCT Filed: Sep. 30, 2014
(86) PCT No.: PCT/JP2014/076094

§ 371 Date: Mar. 30, 2016

(30) Foreign Application Priority Data
Oct. 2, 2013 (JP) 2013-217797

(51) Int. Cl. B23D 63/16; B23D 63/12

(52) U.S. Cl. CPC B23D 63/162; B23D 63/123

(57) ABSTRACT

Manually setting each tooth has been the only available method for setting a chain saw for both inexperienced and experienced users. An automatic saw set is provided wherein blades such as round files are held by a loop-like chain link so as to allow the blades to rotate at the same angle as the staggered uniform teeth of a chain saw and set said teeth. A clamp is used to integrate a guide plate of the target chain saw and a saw set frame, which forms a rotation mechanism from sprockets placed at both ends thereof, so as to enable setting by driving either the guide plate or the frame.

### CROSS REFERENCE FOR RELATED APPLICATIONS

This application is a §371 National Phase of Ser. No.:PCT/JP2014/076094 filed Sep. 30, 2014, the entire contents of which are incorporated by reference, which in turn claims priority from JP Ser. No.: 2013-217797 filed Oct. 2, 2013.

### FIGURE SELECTED FOR PUBLICATION

FIG. 1

### BACKGROUND OF THE INVENTION

1. Field of the Invention

The present invention relates to an operation and device used to automatically and easily tooth cutter links (cutting teeth) of a chainsaw.

2. Description of the Related Art

To date, no tool operative to automatically tooth cutter links (cutter teeth) of a conventional chainsaw is disclosed other than the saw set that tooths automatically using the inside R-shape whetstone during setting the exclusive cutting teeth on the outside.

### PRIOR ART

### Patent Document

Patent Document 1: JP Patent Published 2012-152888

Patent Document 2: JP Patent Published 2011-143485

Patent document 3: JP Patent Published 2004-142004

### ASPECTS AND SUMMARY OF THE INVENTION

In response, it is now recognized that an improved method is needed to replace the manual setting of each tooth in a chain saw for both experienced and inexperienced operators. The present invention provides an automatic saw set for saw chain teeth of a chain saw, the cutting-grinding cutter (e.g., round file and so forth) attachable and detachable and keeping the same distance relative to the traveling direction and having an equal angle formed right-and-left alternatively (zigzag) is held rotatably in the looped chain links of the saw set, the looped chain is attached to the sprocket at both ends of the saw set and has the mechanism to keep rotation, and the saw set further comprising the frame holding the sprocket and the guide plate of the chainsaw subject to toothing are clamped in the right position to integrate the chainsaw and the saw set. It will be understood that the phrases ‘chainsaw’ (single word) and ‘chain saw’ (two words) when used as descriptive nouns represent similar devices.

### Problems to be Solved by the Invention

The problem to be solved is that the operation of continuous automatic toothing is difficult because cutter links (cutting teeth) on the chain of the chainsaw are keeping a distance relative to the traveling direction and are in place with an angle formed right-and-left alternatively.

### Means for Solving the Problem

The purpose of the present invention is to provide the structure, in which cutter links (cutting teeth) on the chain of the chainsaw are keeping the same distance relative to the traveling direction and are in place with an equal angle formed right-and-left alternatively, that allows the chainsaw, which is linked by the endless continuous chain, to perform toothing operation continuously and automatically, wherein the cutting-grinding cutter (e.g., round file and so forth) is held rotatably in the looped chain link of the saw set with the same distance in the identical direction to the cutting traveling direction and the same angle as the angle of the cutter links (cutting teeth) relative to the cutter links (cutting teeth) on the chain attached to the chainsaw with adequate tension, the looped chain is attached to the sprocket in place at both ends of the saw set and has the mechanism to keep rotation, and the frame of the saw set holding the sprocket and the guide plate of the chainsaw are clamped in the right position to integrate the chainsaw and the saw set.

The saw set and the chainsaw are integrated so that when the chain of the chainsaw or the looped chain of the saw set rotate. the cutting-grinding cutter (e.g., round file and so forth) can be pulled to the cutter links (cutting teeth) of the chainsaw and can contact to the cutter links (cutting teeth), while rotating per se on the backing plate, to perform loathing, and therefore the toothing operation can be most principally conducted by repeating gearing (connection)-and-separation between the cutting-grinding cutter (e.g., round file and so forth) and the cutter links (cutting teeth) at the up-and-down element of the sprocket rotation position.

### Effect of the Invention

The cutter links (cutting teeth) and the cutting-grinding cutter (e.g., round file and so forth) connectively contact each other to perform toothing so that the driving source of either the chain of the chainsaw or the looped chain of the saw set can rotate the automatic saw set for a chainsaw according to the aspects of the present invention to continuously connect-and-contact and therefore the toothing operation can be done advantageously.

The above and other aspects, features and advantages of the present invention will become apparent from the following description read in conjunction with the accompanying drawings, in which like reference numerals designate the same elements.

### BRIEF DESCRIPTION OF THE DRAWINGS

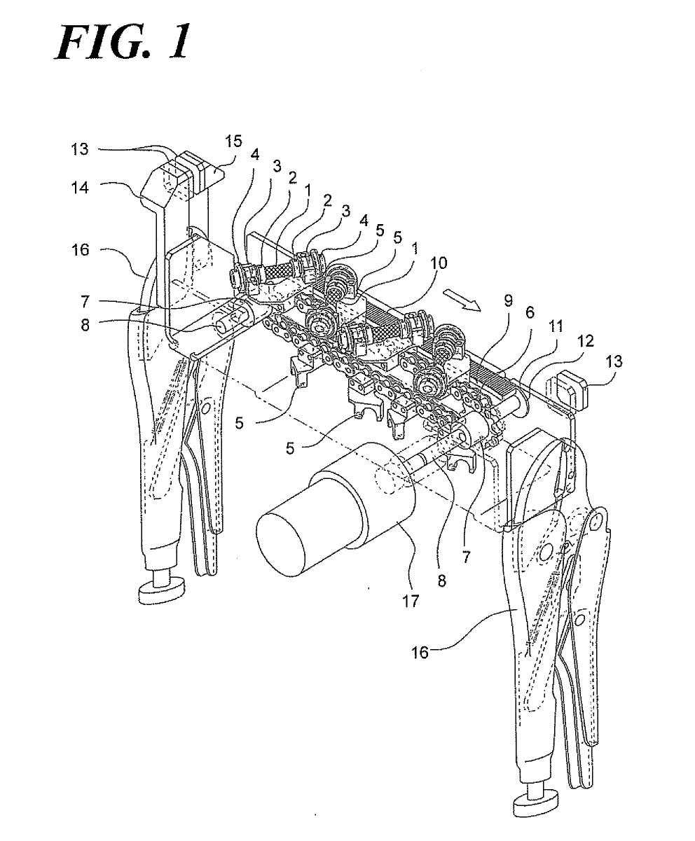

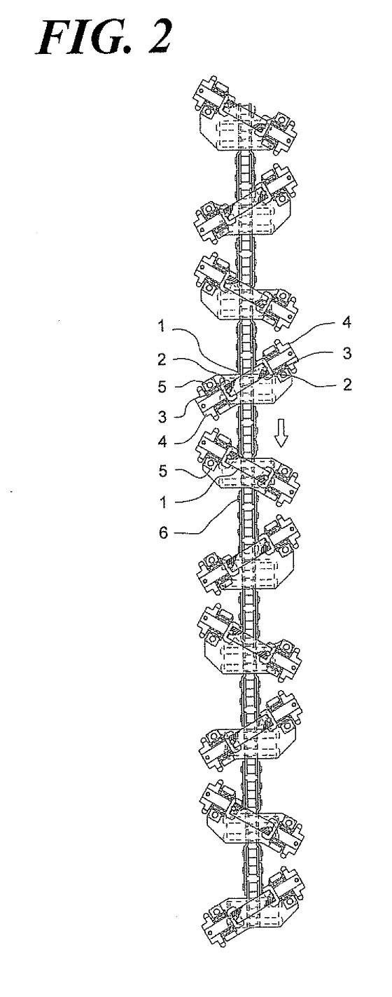

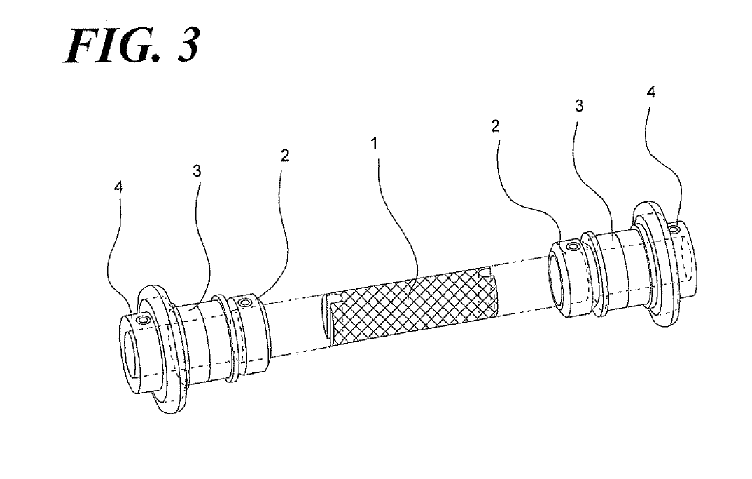

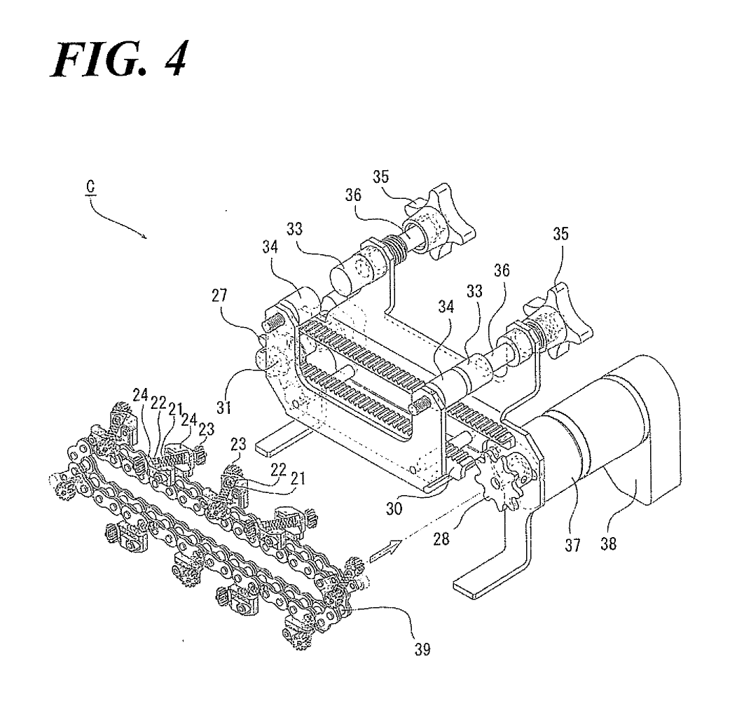

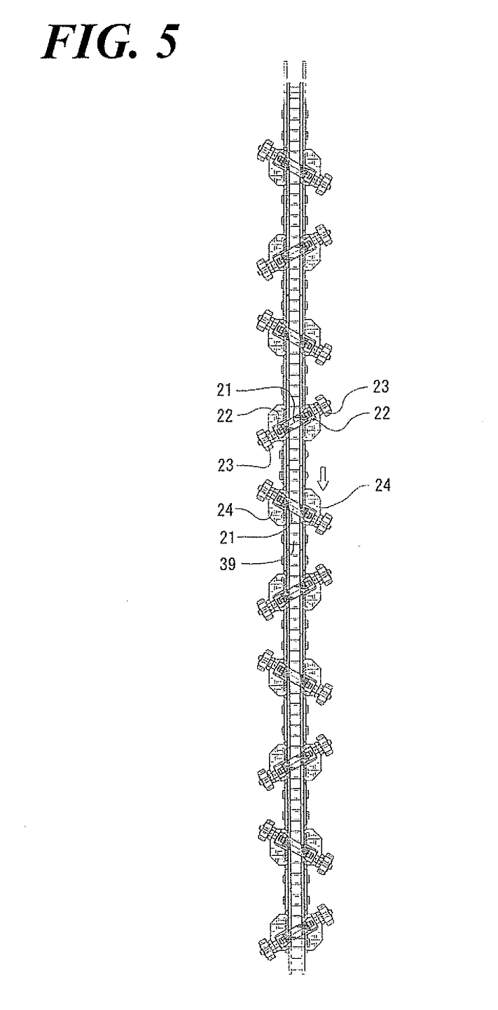

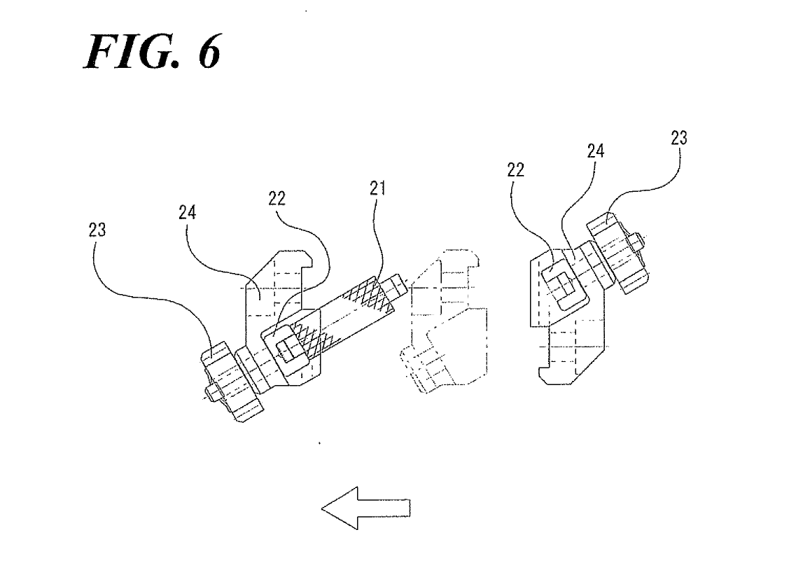

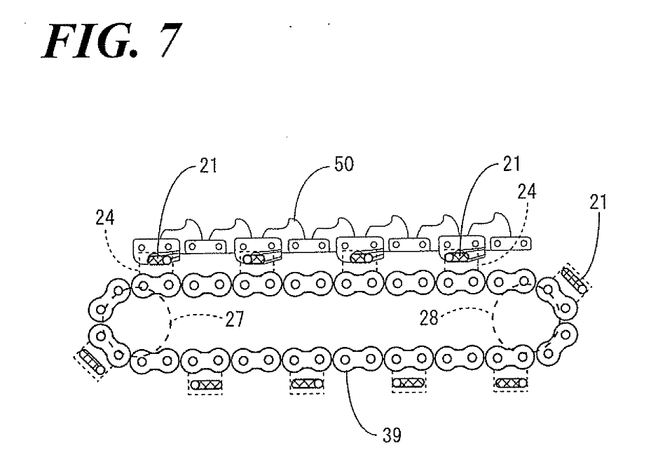

FIG. 1 is a partially enhanced perspective view illustrating the method of an automatic saw set for a chainsaw. (EMBODIMENT 1)

FIG. 2 is a partially enhanced cross section view illustrating the method of an automatic saw set for a chainsaw. (EMBODIMENT 1)

FIG. 3 is a partially exploded perspective view illustrating the method of an automatic saw set for a chainsaw. (EMBODIMENT 1)

FIG. 4 is a perspective view illustrating a saw set for saw chain cutting teeth according to the aspect of the Embodiment 3.

FIG. 5 is a plan view illustrating a cutting-grinding cutter of the saw set for the saw chain cutting teeth according to the aspect of the Embodiment 3.

FIG. 6 is an expanded view illustrating the attaching structure of the cutting-grinding cutter of the saw set for the saw chain cutting teeth according to the aspect of the Embodiment 3.

FIG. 7 is an explanatory drawing illustrating the state of toothing the saw chain by the saw set for the saw chain cutting teeth.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

According to one aspect of the present invention, the chainsaw and the saw set are integrated in the right position by clamping so that the automatic saw set for a chainsaw with minimal number of parts can be brought into reality because the saw set has no driving source according to the aspect of the Embodiment 1 and the configuration having a driving source according to the aspect of the Embodiment 2 can be brought into reality.

### Embodiment 1

FIG. 1 is a partially enhanced perspective view illustrating the actual example of the aspect of the Embodiment 1 relative to the device of the present invention and signs 1-6 therein are the same as in FIG. 2. In addition, the arrow indicates the traveling direction of chainsaw cutting in both FIG. 1, FIG. 2. The synchronization sprocket 7 is fixed to the axis 8 and incorporated into the frame 11 via the bearing 12, and is looped by the synchronization endless and continuous chain-like chain links 6 connecting the connection housing 5.

A cutting cutter 1 can be a round file or a spiral mill or a grinding cutter can be like a whetstone and so forth, a holder 2 can fix the cutter as well as can be a guide fitting to the width of the chainsaw, and a rubber tire or a gear 4 installed outside so that a friction board or a rack gear 10 on the backing plate 9 can contact to the cutting teeth of the chain saw while rotating to perform the toothing operation. In addition, the holder 2 is held by a bearing 3 and connected to a connection housing 5 and incorporated zigzag to the synchronization endless and continuous chain-like chain links 6 attached to the synchronization sprocket 7 at both ends. Since the present invention relates mostly to the method therefor, a chain pitch, a cutter size and an angle are not set forth here.

Relative to a general clamping, a locking plier 16 fixed to a frame 11, a fixing arm 14 attached with a cushion 13 on the tip thereof and a clamp aim 15 integrate the chainsaw and the saw set by clamping the guide plate of the chainsaw at the right potion.

Referring to FIG. 1, as illustrated in the connection housing 5 facing downward, the cutting cutter 1, the holder 2, the bearing 3, the rubber tire or gear 4 are not shown in FIG. 3, but as illustrated in the explosion view of FIG. 3, one set including the cutting cutter 1, the holder 2, the bearing 3, the rubber tire or gear 4 is as one unit, which can be attached or detached, can be replaced as for the cutting cutter 1 as a consumable replacement.

The above configuration comprises at least four cutting cutters 1 zigzag in place, wherein one of either right or left cutter links (cutting teeth) and the cutting cutters of the chainsaw, which are in place alternatively on the backing place 9, is geared so that the driving travel can take place to conduct toothing operation thereon. Nevertheless, the minimal number of configurations of the cutting cutters 1 in place may be required more than 10 depending on the pitch configuration of the cutter links (cutting teeth) which are subject to toothing operation.

### Embodiment 2

According to an actual example of the aspect of the Embodiment 2 of the device of the present invention, the basic configuration is the same as the configuration of the aspect of the Embodiment 1, wherein the synchronization sprocket 7 is fixed and a motor 17 as a driving mechanism is connected to the axis 8 so that the rotation driving can takes place to bring the safer saw set into realty.

### Embodiment 3

Referring to FIG. 4-FIG. 7, the inventor sets forth a saw set C for a chainsaw according to the different aspect from the Embodiment 1, 2.

### (Configuration)

The inventor sets forth the configuration. Referring to FIG. 4-7, a saw set C for a saw chain, according to the present Embodiment, comprises; a frame 31 having the saw chain hold means; a chain 39, which is a wrapping drive element, is wrapped movably around the frame 31; a plurality of holders 24 attached zigzag to the chain 39, which is the wrapping drive element; a rack gear 30 fixed to the frame 31; a pinion gear 23, which is attached movably to each holder 24, that rotates by gearing the rack gears 30, 30 when the chain 39 travels; and a cutting cutter 21, which is fixed to each pinion gear 23, that cuts and grinds the saw chain teeth by rotating with the pinion gear.

The frame 31 comprises the saw chain holding means at the upper side thereof. The saw chain holding means comprises a handle 35 attached to the end of the screw shaft 36; a movable jaw cushion 33, which is attached to the opposite end of the screw shaft 36; that travels when the handle 35 is rotated; and the fixed jaw cushion 34. Accordingly, the guide bar of the chainsaw can be clamped between the fixed jaw cushion 34 and the movable jaw cushion 33. Further, a motor 37 and a chain 39 and so forth are in place underside of the frame 31.

The chain 39 is a synchronization endless and continuous chain-like chain links as the wrapping drive element wrapped around the synchronization sprocket, 27, 28 in place at both ends of the frame 31. The driving force of the motor 37 described later is transduced to the rotation and traveling of the cutting cutter 21 by the chain 39. The chain 39 travels approximately parallel to the rack gear 30 between the sprocket 27, 28 when moved to the upper side.

The holder 24 holds rotatably the cutting cutter 21 and the pinion gear 23 through the axle bearing 22. The holders 24 are zigzag in place relative to the chain 39. Specifically, referring to FIG. 5, FIG. 7, the holder 24 complying with the shape of the saw chain is fixed to the link, constructing the chain 39, every other link while veering one after the other the direction thereof.

Each of the rack gears 30 is in place, sandwiching the chain 39 at both right-and-left side of the frame 31. Each rack gear 30 transduces the driving force due to the traveling of the chain 39 to rotation of the cutting cutter 21 by gearing to the pinion gear 23 traveling along with the chain 39.

The pinion gear 23 is fixed to both ends of the cylinder-shaped cutting cutter 21 in the axle direction thereof and rotates by gearing the rack gear 30 when the chain 39 travels. Then, the cutting cutter 21 fixed integrally to the pinion gear 23 rotates as well.

The cutting cutter 21 is a round file made of ceramic or metal material formed into the cylinder shape. The cutting cutter 21 can be detached from the holder 24 and accordingly is replaceable when galled. The attached cutting cutter 21 is tilted to the traveling direction of the chain 39 (the identical direction of the saw chain.) Specifically, the rotation axis of the cutting cutter 21 is not perpendicular to the traveling direction of the chain 39 and tiled just at the same degree as the tooth angle (e.g., 30 degree.)

And the saw set C of the present Embodiment for the saw chain comprises the motor 37 and a switch box 38 as the driving device to drive the chain 39. Accordingly, the driving force of the saw set C per se instead of the driving force of the chainsaw per se can be used for toothing.

Further, the saw set C of the aspect of the present Embodiment for the saw chain may comprise a dummy guide bar (not shown in FIG.) to hold the saw chain with the movable jaw cushion 33 and the fixed jaw cushion 34 in the state when the saw chain is being detached from the guide bar of the chainsaw. The configuration of the dummy guide bar may be approximately the same as the configuration of the actual chainsaw. In this way, the toothing of the teeth of the saw chain can be performed without adding load (induced electromotive force) to the motor of the chainsaw.

Operation of the Invention

Next, referring to FIG. 7, the inventor sets forth the aspect of the present Embodiment, in which the saw set C for the teeth of saw chain tooths the saw chain 50. The saw chain 50 is in place above the chain 39 and approximately parallel to the linearly extending upper side of the chain 39. And cutters (cutter links) of the saw chain are in place corresponding to the holder 24 attached zigzag to the chain 39 and cutting cutters 21.

Then, the cutting cutters pull the cutter links of the chainsaw and contact to the cutter links (cutting teeth) while rotating on the rack gear 30 (backing plate) by rotating the looped chain 39 of the saw set C. Then, the cutting cutter 21 repeats to connect to and separate from the cutter links (cutting teeth) at the up-and-down element of the rotation position of the synchronization sprockets 27, 28. Accordingly, the cutting cutter 21 rotates while the chain 39 of the saw set C is traveling so that the teeth of the saw chain can be ground.

Effect of the invention

Next, the investor sets forth the effect of the saw set C for a saw chain in bullets according to the aspect of the present Embodiment.

(1) A saw set C for a saw chain of a chain saw, according to the aspect of the present Embodiment, comprises; a frame 31 having the saw chain holding means; a chain 39, which is a wrapping drive element, is wrapped movably around the frame 31; a plurality of holders 24 attached zigzag to the chain 39; a rack gear 30, 30 fixed to the frame 31; a pinion gear 23, which is attached movably to each holder 24, that rotates by gearing the rack gears 30, 30 when the chain 39 travels; and a cutting cutter 21, which is fixed to each pinion gear 23, that cuts and grinds the saw chain teeth by rotating with the pinion gear 23. Accordingly, the teeth of the saw chain can be continuously cut and ground.

(2) The wrapping drive element is the chain 39 and the chain 39 has the identical pitches so that the teeth of the saw chain can be effectively ground. In addition, a commercial chain can be applied for the chain 39 with some modification.

(3) Further, comprising the motor 37 and the switch box 38 as the driving device to drive the chain 39 as the wrapping drive element allows grinding the teeth of the saw chain without applying the driving force of the chain saw per se. Further, the rotation speed of the motor 37 is adjustable so that the grinding can be performed safe.

(4) The saw chain detached from the guide bar of the saw chain is held by the additional dummy guide bar so that grinding the teeth of the saw chain can be performed without adding the load to the driving device of the chainsaw per se.

Meantime, since other configuration and the operation and the effect are approximately same as the previously described aspect of the Embodiment, the inventor will not set forth.

The inventor sets forth the detail of the aspect of the Embodiment of the present invention, any specific configuration is not limited to such Embodiment and any modification is included in the present invention unless departing of the scope of the aspects of the present invention.

Field of the Invention

Conventionally, the toothing operation for the chainsaw is an important training class for the chainsaw operator in the earlier session, and even for an expert, there is no way other than that the teeth must be toothed manually tooth by tooth. When the automatic saw set for the chainsaw according to the present device is applied, both beginner and expert can perform toothing operation to provide as if new cutter links (cutting teeth) in a short period of time out of the galled state due to use regardless the technology level.

It will be understood by those of skill in the art that a chainsaw (the powered device used for cutting) employs a rotating chain (chain) having cutting teeth thereon for cutting purposes, and that the saw set is for the teeth of the chain for use with a chainsaw.

### REFERENCE OF SIGN

C Saw sets of saw chain
1 Cutting cutter
2 Holder
3 Bearing
4 Rubber tire or gear
5 Connection housing
6 Synchronized endless continuous chain link
7 Synchronized sprocket
8 Axis
9 Backing plate
10 Friction board or rack gear
11 Frame
12 Bearing
13 Cushion
14 Fixing arm
15 Clamp arm
16 Locking pliers
17 Motor
21 Cutting cutter
22 Axle bearing
23 Pinion gear
24 Holder
27, 28 Synchronized sprocket
30 Rack gear
31 Frame
33 Movable jaw cushion
34 Fixed jaw cushion
35 Operation handle
37 Motor
38 Switch box
39 Chain
50 Saw chain

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1. A saw set for saw chain teeth of a chainsaw chain, comprising;
a frame having a chain holding means;
a wrapping drive element that is wrapped movably around said frame;
a plurality of holders attached in a zigzag manner to said wrapping drive element;
a rack gear that is fixed to said frame;
a pinion gear that is attached rotatably to each said holder;
a cutting cutter that is fixed to each pinion gear; and
wherein said pinion gear rotates by a gearing to said rack gears when said wrapping drive element travels, and said cutting cutter cuts and grinds said saw chain teeth by rotating along with said pinion gear.

2. A saw set for saw chain teeth of a chainsaw chain, according to claim 1, wherein:
said wrapping drive element includes a chain and said chain has the identical pitch to the pitch of said saw chain.

3. A saw set for saw chain teeth of a chainsaw chain, according to claim 1, further comprising:
a driving device that drives said wrapping drive element.

4. A saw set for saw chain teeth of a chainsaw chain, according to claim 1, further comprising:
a dummy guide bar positioned to hold said saw chain detached from a guide bar of said chainsaw using said saw chain holding means.

5. An automatic saw set, for saw chain teeth of a chainsaw chain, wherein a cutting-grinding cutter that is attachable and detachable and keeps the same distance relative to a defined traveling direction in a zigzag manner and is held rotatably in respective looped chain links of the saw set, and a looped chain is attached to a sprocket in place at both ends of the saw set and has a mechanism to keep rotation during a use, and
the automatic saw set comprising:
a frame holding the sprocket and the guide plate of the chainsaw subject to soothing are clamped in a position to integrate the chainsaw and the saw set during said use.
